(19) United States
(12) Patent Application Publication
(10) Pub. No.: US 2026/0084592 A1
(43) Pub. Date: Mar. 26, 2026

(54) CHILD SEAT ANCHORING DEVICE

(71) Applicants: Ryan Tyler McLellan, Blairmore (CA); Carolyn Amy Kicey, Blairmore (CA)

(72) Inventors: Ryan Tyler McLellan, Blairmore (CA); Carolyn Amy Kicey, Blairmore (CA)

(21) Appl. No.: 18/892,717

(22) Filed: Sep. 23, 2024

(51) Int. Cl. B60N 2/28

(52) U.S. Cl. CPC B60N 2/28

(57) ABSTRACT

A child seat anchoring device that is configured to be operably coupled to a floorboard of a car and tethered to a child car seat so as to inhibit vertical, horizontal and lateral movement of the car seat. The device includes a body wherein the body is manufactured from a rigid material having a first portion and a second portion. The first portion includes a plurality of apertures having fasteners therethrough configured to secure to a floorboard. The second portion of the body is angularly oriented to the first portion. The second portion includes an aperture wherein the aperture is suitable in size to be operably coupled with a tether from a child car seat. The aperture is mateably shaped with the second portion. An alternate embodiment provides a body having a first lower slot and second lower slot positioned with a central aperture providing tether locations.

### FIELD OF THE INVENTION

The present invention relates generally to vehicle safety equipment, more specifically but not by way of limitation, a child car seat anchor that is mounted to the floorboard of a vehicle wherein the present invention provides a central axis anchoring point operable to inhibit lateral movement of the child car seat.

### BACKGROUND

Vehicles in North America aren't required to have dedicated lower anchors specifically for the center rear position, and as such many makes and models of vehicles lack this feature, especially trucks. Federal regulators only require two rear seating positions to have dedicated lower anchors with a standard spacing of eleven inches, which is enough room for a child seat. Some automakers produce cars without dedicated middle-seat lower anchors and have an anchor from each outboard seat position that can be used to securely install a car seat in the middle. This configuration leverages an anchor from each opposing side of the car seat location. In this configuration, the spacing between the anchors could be wider, so the specific car-seat manufacturer also needs to allow for this type of installation.

LATCH is an acronym that stands for Lower Anchors and Tethers for Children. It includes the lower anchors found at the seat crease and the top tether anchor often found on the back shelf or behind the rear seat. A LATCH installation generally means attaching the car seat with the lower anchors, not the seat belt. The top tether should be attached to the tether anchor for all forward-facing car-seat installations, whether using the seat belt or lower anchors. The standard spacing between the anchors is eleven inches, but when leveraging across lower anchors for a center seat installation, the spacing no longer adheres to the regulated eleven inches. It is important to understand the spacing of the anchors located in the car in which a user will mount a car seat. Parents and caretakers of children are often surprised by how many vehicles lack a central tether point for car seat that are optimal for inhibiting movement of the car seat.

Accordingly, there is a need for a mounting bracket that can be centrally located underneath each seat position in a rear seat of a vehicle wherein the present invention provides a central tether point for securing of a car seat.

### SUMMARY OF THE INVENTION

It is the object of the present invention to provide a car seat installation mounting system that is configured to be mounted to a floorboard of a vehicle wherein the present invention includes a body manufactured from a rigid material such as but not limited to metal.

Another object of the present invention is to provide an anchoring element for a car seat that provides a central tethering point for the car seat wherein the body of the present invention includes a first portion and a second portion contiguously formed.

A further object of the present invention is to provide a car seat installation mounting system that is configured to be mounted to a floorboard of a vehicle wherein the second portion of the body is angularly oriented with the first portion of the body.

Yet a further object of the present invention is to provide an anchoring element for a car seat that provides a central tethering point for the car seat wherein the second portion of the body includes an aperture formed therein.

Still another object of the present invention is to provide a car seat installation mounting system that is configured to be mounted to a floorboard of a vehicle wherein the first portion of the body includes apertures and fasteners configured to operably couple the body to the floor board of the vehicle.

An additional object of the present invention is to provide an anchoring element for a car seat that provides a central tethering point for the car seat wherein the body can be mounted on a recess in the floorboard of a vehicle.

Yet a further object of the present invention is to provide a car seat installation mounting system that is configured to be mounted to a floorboard of a vehicle wherein the present invention further includes an adapter embodiment that can be utilized to operably couple to lateral tether points located in a floorboard of a vehicle.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an embodiment of the present invention; and

FIG. 2 is a side view of an embodiment of the present invention; and

FIG. 3 is a side view of an exemplary installation location; and

FIG. 4 is a front view of an alternative embodiment of the present invention.

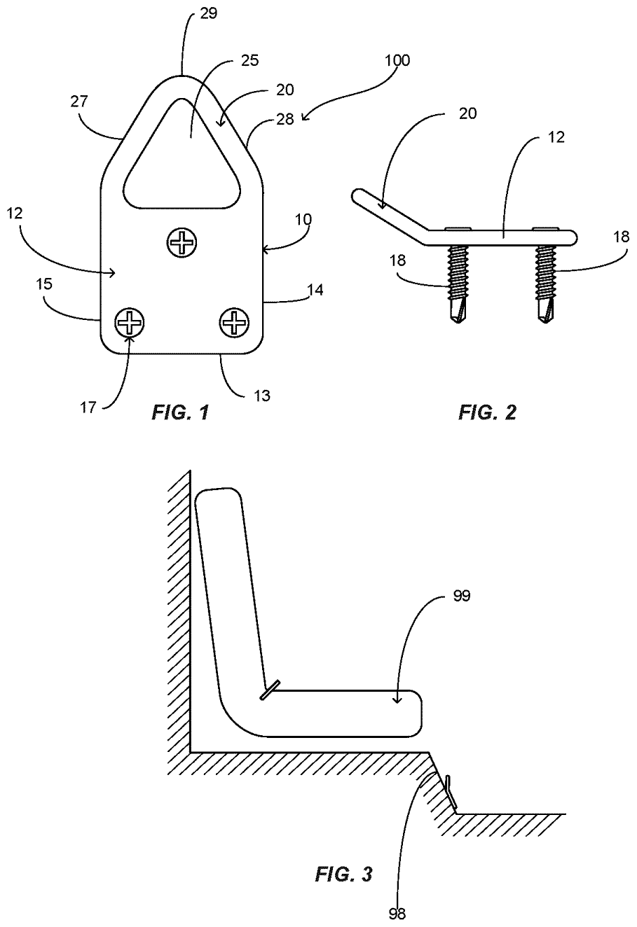

### DETAILED DESCRIPTION

Referring now to the drawings submitted herewith, wherein various elements depicted therein are not necessarily drawn to scale and wherein through the views and figures like elements are referenced with identical reference numerals, there is illustrated a child seat anchoring device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the child seat anchoring device 100 is utilized to provide an additional anchoring point for installation of a child car seat in a motor vehicle. The additional anchoring point functions to inhibit all movement of the child car seat inhibiting lateral, vertical and horizontal movement. It should be understood within the scope of the present invention that the child seat anchoring device 100 could be installed in all types of motor vehicles.

The child seat anchoring device 100 includes a body 10 wherein the body 10 is manufactured from a suitable rigid material such as but not limited to metal. The body 10 includes first portion 12 and second portion 20. Lower portion 12 include lower perimeter edge 13 having opposing lateral edges 14,15. Opposing lateral edges 14,15 are perpendicular to the lower perimeter edge 13. Formed in the first portion are a plurality of apertures 17 wherein the apertures 17 are operable to have fasteners 18 journaled therethrough. The fasteners 18 are utilized to secure the body 10 to the floorboard 98 of the motor vehicle adjacent to the location of the exemplary car seat 99. In a preferred embodiment of the present invention the fasteners 18 are self-tapping metal screws but it should be understood that alternate types of fasteners such as but not limited to bolts could be utilized to secure the body 10 to the floorboard 98. While three apertures 17 are utilized in a triangular pattern for optimal load distribution, it is contemplated within the scope of the present invention that the first portion 12 could have more or less than three apertures 17.

The second portion 20 of the body 10 is contiguously formed with the first portion 12. Second portion 20 is angularly oriented with the first portion 12. In a preferred embodiment of the present invention, the body 10 is configured to be mounted within a recess located on a floorboard 98 of a vehicle. The angular orientation of the second portion 20 of the body 10 provides access to the aperture 25 ensuing the body 10 being mounted in the recess. The second portion 20 includes aperture 25 that is mateably shaped with the second portion 20. The second portion 20 includes upper lateral edges 27,28 that are angular in orientation joining at apex 29 wherein the apex 29 is slightly convex. While the aperture 25 and second portion 20 are illustrated herein as having a particular shape, it is contemplated within the scope of the present invention that the second portion 20 could be provided in alternate shapes.

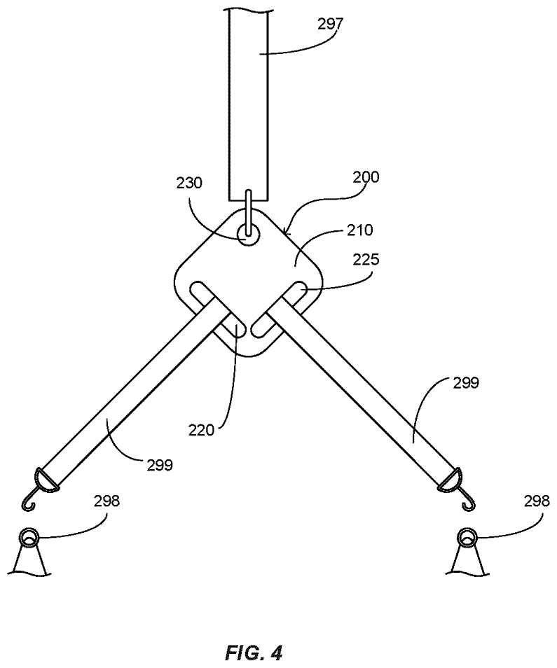

Referring in particular to FIG. 4 submitted herewith, an alternate embodiment of the child seat anchoring device 200 is illustrated therein. The child seat anchoring device 200 includes a body 210 that is planar in manner being manufactured from a rigid material such as but not limited to metal. The body 210 has perimeter edge 212 defining the shape thereof. The child seat anchoring device 200 is configured to provide a three-point connection to secure a child car seat 99 and inhibit movement thereof. The body 210 has a first lower slot 220 and a second lower slot 225 that are angular oriented so as to position tethers 299 towards the anchor points 298. Centrally located on the body 210 proximate the top thereof is central aperture 230. Central aperture 230 is annular in shape and is configured to be operably coupled to upper tether 297. The arrangement of the first lower slot 220, second lower slot 225 with the central aperture 230 provides an orientation for the tethers 297, 299 to be oriented in a triangular manner. This orientation inhibits movement of the child car seat 99 when secured thereto. It is contemplated within the scope of the present invention that the body 210 could be provided in alternate sizes and shapes and achieve the desired function described herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A child seat anchoring device configured to be operably coupled to a floorboard of a vehicle and have a child car seat tethered thereto wherein the child seat anchoring device comprises:
a body, said body having a first end and a second end, said body having a first side and a second side, said body having a first portion and a second portion, said second portion of said body being contiguously formed with said first portion, said first portion having a plurality of apertures formed therein, said plurality of apertures configured to have fasteners journaled therethrough so as to secure said body to the floorboard, said second portion having an aperture formed therein, said aperture of said second portion being mateable in shape to said second portion of said body; and
wherein said second portion of said body in angularly oriented with respect to said first portion.

2. The child seat anchoring device configured to be operably coupled to the floorboard of a vehicle as recited in claim 1, wherein said first portion of said body further includes a lower perimeter edge.

3. The child seat anchoring device configured to be operably coupled to the floorboard of a vehicle as recited in claim 2, wherein said first portion of said body includes opposing lateral edges, said opposing lateral edges being perpendicular to said lower perimeter edge of said first portion of said body.

4. The child seat anchoring device configured to be operably coupled to the floorboard of a vehicle as recited in claim 3, wherein said second portion of said body includes opposing upper lateral edges, said upper lateral edges being angular and joined at an apex.

5. The child seat anchoring device configured to be operably coupled to the floorboard of a vehicle as recited in claim 4, wherein the apex is convex in shape.

6. The child seat anchoring device configured to be operably coupled to the floorboard of a vehicle as recited in claim 5, wherein said aperture formed in said second portion is triangular in shape.

7. A child seat anchoring device configured to facilitate a three-point connection with a child car seat and a vehicle wherein the child seat anchoring device comprises:
a body, said body being planar in manner, said body having a first side and a second side, said body having a perimeter edge defining a shape thereof, said body having a first lower slot and a second lower slot, said first lower slot and said second lower slot being proximate a bottom end of said body, said body having a central aperture, said central aperture being annular in shape, said central aperture being located proximate an upper end of said body.

8. The child seat anchoring device configured to facilitate a three-point connection with the child car seat and a vehicle as recited in claim 7, wherein said first lower slot and said second lower slot are angularly oriented with respect to each other.

9. The child seat anchoring device configured to facilitate a three-point connection with the child car seat and a vehicle as recited in claim 8, wherein said central aperture is axially intermediate ends of said first lower slot and said second lower slot.

10. The child seat anchoring device configured to facilitate a three-point connection with the child car seat and a vehicle as recited in claim 9, wherein said first lower slot, said second lower slot and said central aperture are oriented so as to form a triangular arrangement of tethers secured thereto.
